(19) United States
(12) Patent Application Publication
(10) Pub. No.: US 2021/0011714 A1
(43) Pub. Date: Jan. 14, 2021

(54) SYSTEM, METHOD AND COMPUTER-ACCESSIBLE MEDIUM FOR PREDICTING A TEAM'S PULL REQUEST COMMENTS TO ADDRESS PROGRAM CODE CONCERNS BEFORE SUBMISSION

(71) Applicant: Capital One Services, LLC, McLean, VA (US)

(72) Inventors: Jeremy GOODSITT, Champaign, IL (US); Reza FARIVAR, Champaign, IL (US); Fardin Abdi Taghi ABAD, Champaign, IL (US); Austin WALTERS, Savoy, IL (US)

(21) Appl. No.: 16/508,848

(22) Filed: Jul. 11, 2019

(51) Int. Cl. G06F 8/73; G06F 11/36; G06N 3/08; G06N 20/00

(52) U.S. Cl. CPC G06F 8/73; G06N 20/00; G06N 3/08; G06F 11/3604

(57) ABSTRACT

An exemplary system, method, and computer-accessible medium for providing feedback on a section(s) of computer code, can include receiving the section(s) of computer code, analyzing a portion(s) of the section(s), and providing the feedback on the analyzed portion using a machine learning procedure. The machine learning procedure can be a recurrent neural network. The portion(s) can be automatically identified (e.g., using a computer). The portion can be identified based on a label(s) associated with the portion(s). The label(s) can be located in a comments section associated with the computer code. The portion(s) can be a topic model associated with the computer code. The feedback can include an approval or a rejection of the portion(s). Semantics of the portion(s) can be identified, and feedback can be provided based on the semantics.

### FIELD OF THE DISCLOSURE

The present disclosure relates generally to review of computer code, and more specifically, to exemplary embodiments of an exemplary system, method, and computer-accessible medium for providing feedback on at least one section of computer code.

### BACKGROUND INFORMATION

Code review is a software quality assurance activity in which one or several coders check a program mainly by viewing and reading parts of its source code, which can be performed before or after implementation of the software. This can be performed by coders collaborating on a piece of software, or outside coders can be brought in to review the code. Regular change-based code review can be a review that is based on the changes to the codebase performed in some other unit of work (e.g., one coder makes changes to the code, and other coders review the changes at a later time). To perform change-based reviews, authors and reviewers generally use software tools (e.g., pastebins and IRC, or specialized tools designed for peer code review such as Gerrit and Github).

Code reviews require a considerable investment of effort from the coders as one or more coders needs to put their current project on hold just to review the work of another coder. This can be a tedious task, and can split the focus of the reviewer as the code reviewer will need to multitask to review someone else's code. For example, a code reviewer may need to review a code to determine if mistakes have been made, or to determine if the code does not conform to one or more standards that have been created by the coding team, or the organization as a whole. This can be even more tedious when acclimating a new coder to a coding team, as the new coder may not be aware of the standards or requirements of the coding team. Thus, manual code review of another coder's work, while a necessary process, is extremely inefficient, and is a poor use of company resources.

Thus, it may be beneficial to provide an exemplary system, method, and computer-accessible medium for providing feedback on at least one section of computer code which can overcome at least some of the deficiencies described herein above.

### SUMMARY OF EXEMPLARY EMBODIMENTS

An exemplary system, method, and computer-accessible medium for providing feedback on a section(s) of computer code, can include receiving the section(s) of computer code, analyzing a portion(s) of the section(s), and providing the feedback on the analyzed portion using a machine learning procedure. The machine learning procedure can be a recurrent neural network. The portion(s) can be automatically identified (e.g., using a computer). The portion can be identified based on a label(s) associated with the portion(s). The label(s) can be located in a comments section associated with the computer code. The portion(s) can be a topic model associated with the computer code. The feedback can include an approval or a rejection of the portion(s). Semantics of the portion(s) can be identified, and feedback can be provided based on the semantics.

In some exemplary embodiments of the present disclosure, the feedback can be provided by using the machine learning procedure to determine if the portion(s) is expected code or unexpected code. The section(s) can be continuously received, and checked. The portion(s) can be analyzed by comparing the portion(s) with a previous portion of a further computer code. A determination can be made as to whether the portion(s) will be rejected or accepted based on the analysis of the portion(s). The feedback can include highlighting an area(s) of the portion(s). The feedback can include a text output including a description of any issues determined with the portion(s). The machine learning procedure can be generated, for example, based on manual feedback provided for further computer code.

Additionally, an exemplary system, method, and computer-accessible medium for providing feedback on a section(s) of computer code can include receiving a plurality of further sections of further computer code, generating a model(s) for predicting the feedback based on the further section, receiving a section of computer code(s), providing the feedback by applying the model(s) to the section(s). The model can be a recurrent neural network.

Further, an exemplary system, method, and computer-accessible medium for providing feedback on a section(s) of computer code can include receiving the section(s) of computer code from a user(s), analyzing the section(s) by comparing the section(s) with a previous section of a further computer code to determine if the section(s) will be rejected or accepted, and determining the feedback for the analyzed section(s) by applying a recurrent neural network to the analyzed section(s). The feedback can include an approval or a rejection of the section(s).

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary schematic diagram of a system for analyzing code sections according to an exemplary embodiment of the present disclosure;

FIG. 2 is a flow diagram of a method for providing feedback on a section of code according to an exemplary embodiment of the present disclosure;

FIG. 3 is a schematic diagram of an exemplary RNN according to an exemplary embodiment of the present disclosure.

FIGS. 4-6 are further flow diagrams of methods for providing feedback on sections of code according to an exemplary embodiment of the present disclosure; and

FIG. 7 is an illustration of an exemplary block diagram of an exemplary system in accordance with certain exemplary embodiments of the present disclosure.

### DETAILED DESCRIPTION OF EXEMPLARY EMBODIMENTS

Coding of a software application can be a tedious process. However, manually reviewing the code of other coders can be even more tedious, or unpleasant. It can also be an extremely slow process, and the code reviewer has to manually review each line of code. In contrast to previous manual methods for reviewing code, the exemplary system, method, and computer-accessible medium can automatically analyze code to provide feedback to the initial coder. For example, a coder can generate (e.g., write a section of code). After the coder generates the code, the exemplary system, method, and computer-accessible medium can analyze the code generated by the coder to provide feedback to the coder.

The exemplary system, method, and computer-accessible medium, according to an exemplary embodiment of the present disclosure, can analyze the code generated by the coder in real time, or at specific intervals. For example, as the coder generates the code, the exemplary system, method, and computer-accessible medium can analyze each line of code after it has been finished. The feedback can be provided to the coder in the form of real time feedback (e.g., positive, negative, or other types of feedback), including indicating problem areas. This can include color coding of the generated line of code (e.g., green for positive feedback and red for negative feedback, although not limited thereto). The exemplary system, method, and computer-accessible medium can also analyze, in real time, small sections of code (e.g., for loops, while loops, etc.). Thus, after the exemplary system, method, and computer-accessible medium recognizes that the small section has been complete, based on the code being written in, the code can be analyzed and the feedback can be provided.

Instead of, or in addition to, analyzing the code in real time, the code can be analyzed periodically. For example, the code can be checked at various time intervals that the code is generated (e.g., every 5 minutes, 10 minutes, etc., although not limited thereto). Additionally, the code can be analyzed upon the occurrence of different events. For example, if the coder activates a save function in the coding platform, the exemplary system, method, and computer-accessible medium can analyze the code during the save function, and the feedback can be provided after the save function has completed. The code can also be checked at the end of a code block, or at the beginning of the next code block, which can be based on the language the code is written in. Further, if the coder is working on smaller section of a larger piece of code, the coder may use the coding platform to check out the particular code section. During the checkout, or check, in process, the code can be analyzed and the feedback can be provided. For example, when the coder checks in the code, the analysis can be performed and the feedback can be provided. The coder can be provide with the opportunity to review the feedback, and modify the code as necessary, or the coder can override the feedback and check in the code.

The exemplary system, method, and computer-accessible medium can generate a feedback file based on each code analysis. The feedback file can include bookmarks to particular sections of code, and can provide the feedback for that particular section. A history can be maintained such that a coder can see that a negative feedback was generated, that the code was changed, and then that a positive feedback was generated. Or vice versa. Thus, another coder (e.g., a supervisory coder) can view the feedback results for another coder. This can facilitate an improvement analysis of a particular coder (e.g., a supervisory coder can view how another coder has progressed over time to determine if their coding skills have improved, or if the coder is learning the specific coding style of the supervisory coder's group).

The feedback provided to the coder can take various forms. For example, the feedback provided to the coder can be a positive feedback or a negative feedback. Positive feedback can include an indication that checked code does not include any errors or issues that generally would be caught by another reviewer. Negative feedback can include an identification of one or more sections that have identified problems. Various suitable methods for identifying the code sections can be used, including labels associated with each section. Problems can include, but are not limited to, errors in the code or not adhering to a particular coding style or standard. For example, different coding organizations can have various standards for how coding (e.g., coding a particular function) is to be performed. Thus, anyone else reviewing the code would immediately be able to discern the function that is written. Standards can take years to develop, and can be different based on the coding platform. During the analysis of a particular section of code, the exemplary system, method, and computer-accessible medium can determine if the produced code matches the standards that have been set by the organization. The exemplary system, method, and computer-accessible medium can provide negative feedback if the code produced does not match the standard code. The negative feedback can include only an indication that the code does not match; however, a suggestion can be provided on how to change the code produced to match the standard that has been set. Alternatively, or in addition, the exemplary system, method, and computer-accessible medium can determine what the standard is, and provide the coder with an example of the standard for the coder to emulate.

Negative and positive feedback can take various other forms, including a score which can reflect a match between the code produced and the standard. For example, if the exemplary system, method, and computer-accessible medium is unable to determine a specific standard, and the code produced is similar to more than one standard, then the feedback can include a score of how close the code matches the one or more similar standards. The coder can then review the potential matches to make a determination of the actual match. This feedback can then be used to improve the exemplary system, method, and computer-accessible medium.

In addition to positive and negative feedback, other forms of feedback (e.g., finer grain feedback) can be used. This can include for example, degrees of positive and negative feedback, such as, joy, irritability, anger, and rage, although not limited thereto. Feedback can also include objective feedback, such as the written code will not run, or will not compile correctly, or neutral statements (e.g., technical criticisms), the code is not formatted correctly.

In order to provide feedback to the coder, the exemplary system, method, and computer-accessible medium can utilize a neural network, or any machine learning procedure, to analyze the code. Analysis can be based on semantics related to the coding language. The neural network can be trained on previous sections of code where feedback has been provided. Training can be specific to the coding group working on the particular code (e.g., it can analyze feedback from the current code being generated where manual feedback has been provided). Additionally, other pieces of software that have been generated by the same coding group, or within the same organization, can be used to ensure that the feedback is sufficiently similar to manually-provided feedback. Further, manual feedback from other organizations can be used. For example a repository can be setup (e.g., an open source repository) for a particular coding language that can be used to train the exemplary system, method, and computer-accessible medium. Thus, generalized feedback can be provided if there is no organization-specific manual feedback available. As organization-specific manual feedback becomes available, the exemplary system, method, and computer-accessible medium can be retrained (e.g., updated) based on this new feedback information. Additionally, even if the exemplary neural network is only initially organization-specific trained, the neural network can be updated as more manual feedback is generated by the organization. The exemplary neural network can include a recurrent neural network (“RNN”) as discussed below.

After the feedback is generated by the exemplary neural network, it can be manually reviewed by other coders. This can significantly decrease the manual review time needed, as the other coders are only checking the accuracy of the automatic feedback provided by the neural network. Additionally, as coders provide manual checking of the automatic feedback, the exemplary neural network can learn based on this manual checking to further increase the accuracy of the exemplary system, method, and computer-accessible medium.

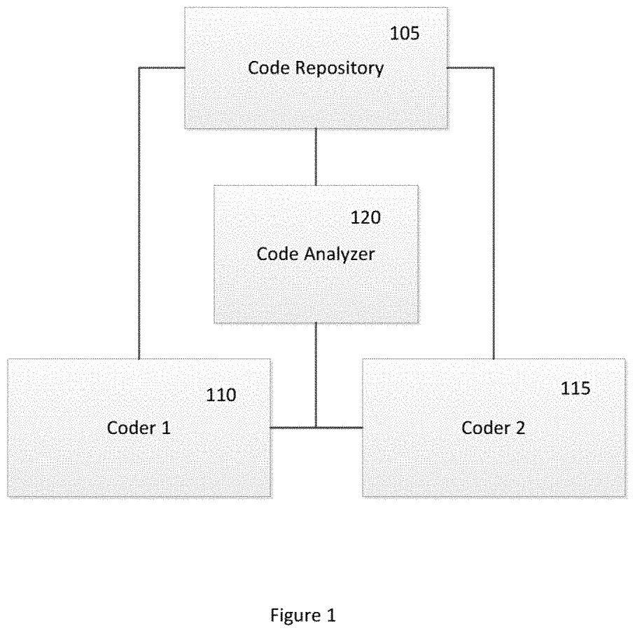

FIG. 1 shows an exemplary schematic diagram of a system for analyzing code sections according to an exemplary embodiment of the present disclosure. For example, a code repository 105 can store one or more sections of code for one or more pieces of software that are currently being coded. Different code portions can be assigned to different coders, for example Coder 1 (e.g., denoted by element 110) and Coder 2 (e.g., denoted by element 115). Each coder, Coders 1 and 2, can check out their respective code portions from Code Repository 105. After, each coder works on their respective section, or during the coding, Code Analyzer 120 can analyze the work performed on the section of code to automatically provide feedback to the coder. When each coder has finished their respective portion, or is temporarily finished, the code portion can be loaded back into Code Repository 105. At a later time, the same coder can check out the same piece of code again to work on that portion. Additionally, another coder can check out the particular portion and manually provide feedback. This manual feedback can be used to retrain, or update, Code Analyzer 120.

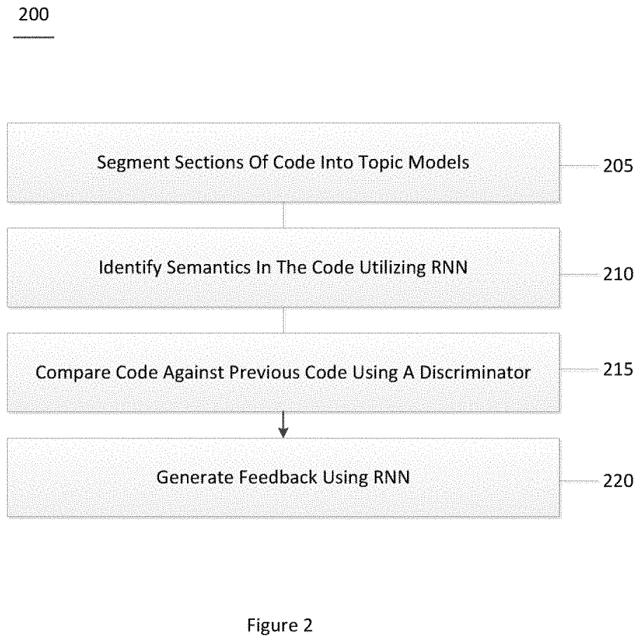

FIG. 2 shows a flow diagram of a method 200 for providing feedback on sections of code according to an exemplary embodiment of the present disclosure. For example, at procedure 205, sections of code can be segmented into given topic models to be identified. These topics can be abstract (e.g., like types of method trying to be achieved for a “for loop”). Within the sections, at procedure 210, the semantics of the code can be identified utilizing an RNN to predict whether or not the expected code within the topic is actually expected code based on positive feedback or unexpected code based on negative feedback. Positive/negative feedback can come from the sentiment of the feedback as well as approval/rejection of previous code. At procedure 215, a discriminator can be used to compare the code against previous code to determine whether or not it is probable to reject/approve the code. If rejected, at procedure 220, topic models/semantic learning of the code can be used in an RNN to generate feedback surrounding the code.

Exemplary Recurrent Neural Network

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. This can make RNNs beneficial for tasks such as unsegmented, connected handwriting recognition, or speech recognition. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (“LSTMs”) and gated recurrent units

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

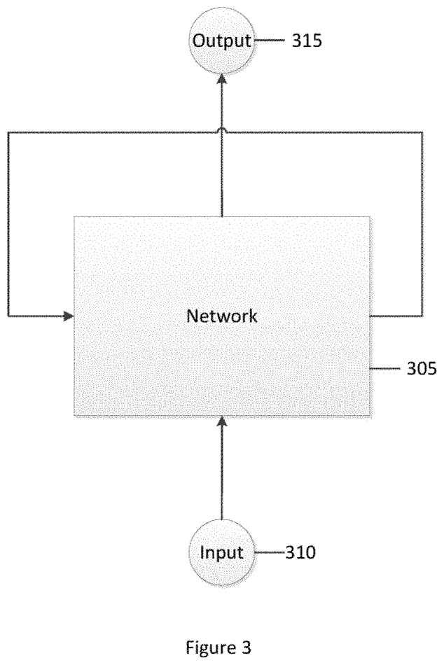

FIG. 3 shows an exemplary RNN according to an exemplary embodiment of the present disclosure. For example, RNNs can be networks with loops in them, allowing information to persist. As shown in FIG. 3, neural network 305 can include an input 310 and an output 315. RNN 105 can analyze input 310 and provide output 315. RNN 305 can include a feedback loop. The feedback loop shown in FIG. 3 allows information to be passed from one step of the network to the next. A RNN can be considered as multiple copies of the same network, each passing a message to a successor.

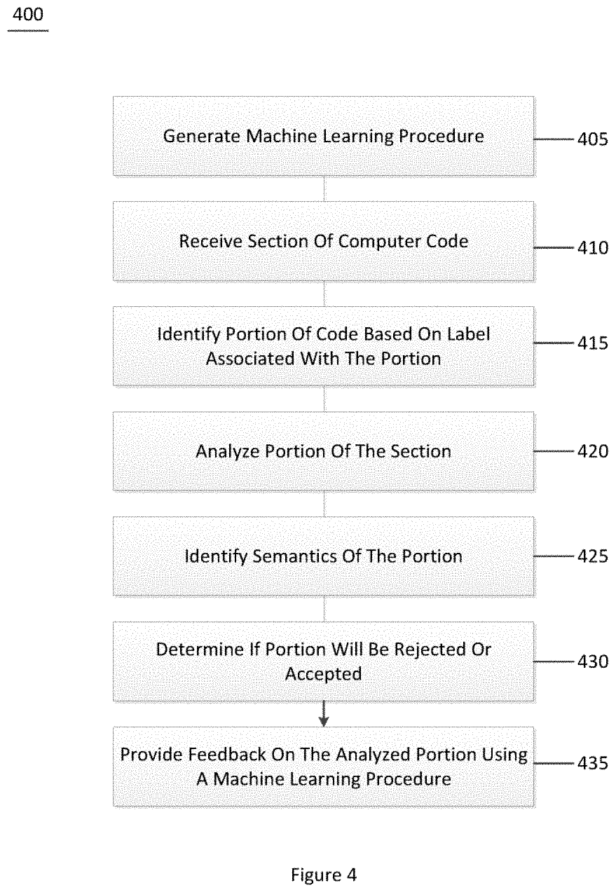

FIGS. 4-6 are further flow diagrams of methods 400, 500, and 600 for providing feedback on sections of code according to an exemplary embodiment of the present disclosure.

For example, as shown in FIG. 4, at procedure 405, a machine learning procedure (e.g., a neural network such as a RNN) can be generated. At procedure 410, a section of computer code can be received (e.g., after a coder drafts the code). At procedure 415, portions of the code can be identified based on labels associates with the portions. At procedure 420, the portion of the section of code can be analyzed. At procedure 425, semantics can be identified in the portion of the code. At procedure 430, a determination can be made as to the portion will be accepted or rejected. Other determinations about the code can also be made at such time. At procedure 435, feedback on the analyzed code can be provided based on the machine learning procedure.

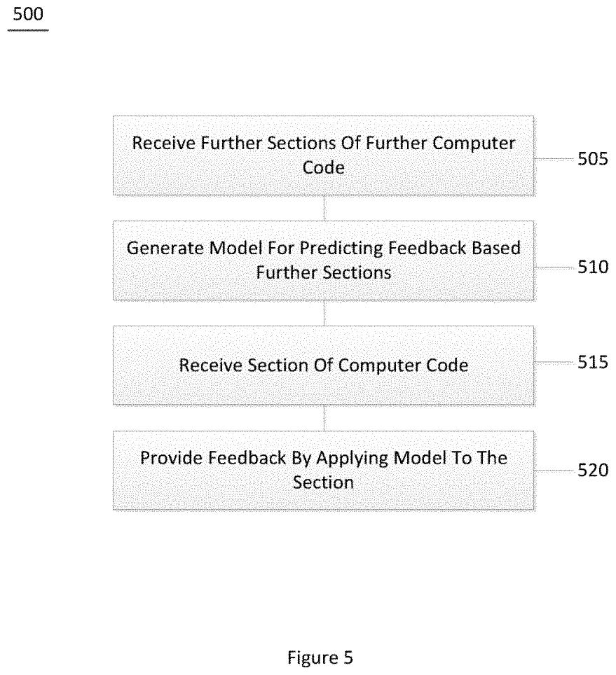

As shown in FIG. 5, at procedure 505, further sections of code that are different than the specific section of code being analyzed, can be received. At procedure 510, a model for analyzing code sections can be generated based on the further sections. At procedure 515, a section of computer code to be analyzed can be received. At procedure 520, feedback on the specific section of code can be provided by applying the model to the specific section of code.

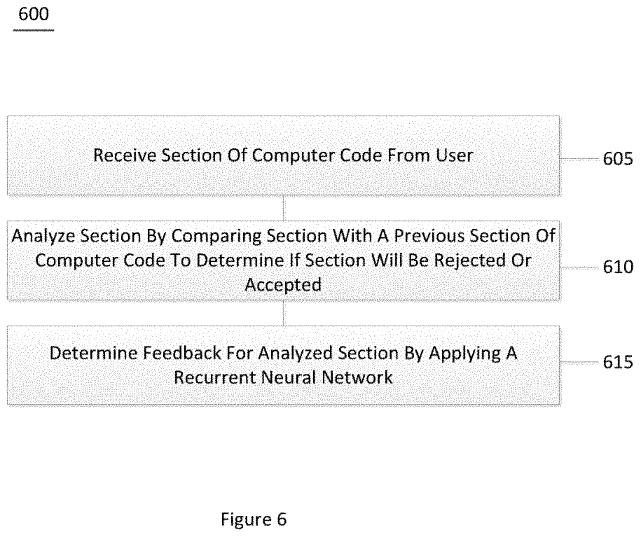

As shown in FIG. 6, at procedure 506, a section of computer code can be received from a user. At procedure 610, the section of code can be analyzed by comparing the section with a previous section to determine if the current section will be accepted or rejected. At procedure 615, feedback for the section can be determined by applying a RNN.

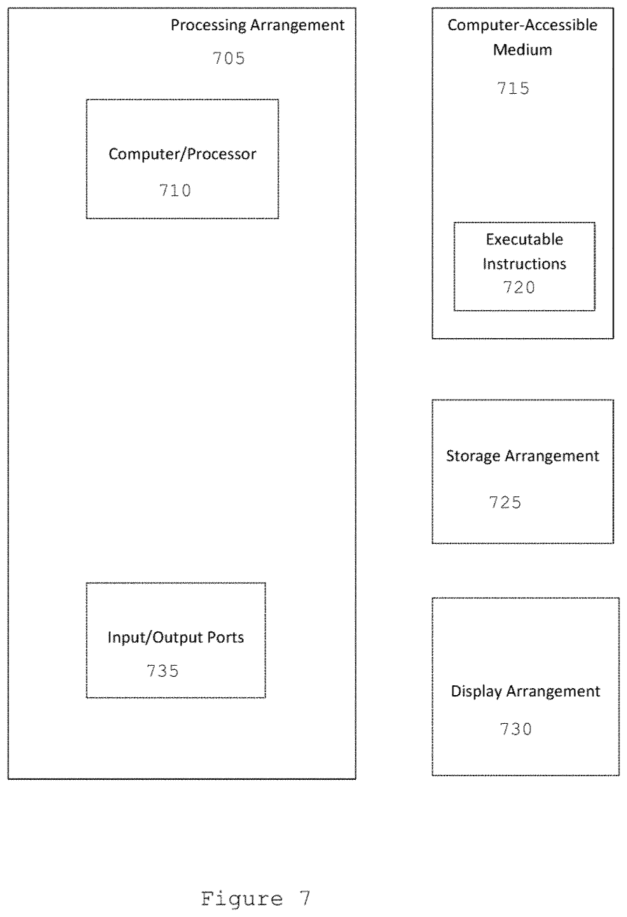

FIG. 7 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 705. Such processing/computing arrangement 705 can be, for example entirely or a part of, or include, but not limited to, a computer/processor 710 that can include, for example one or more microprocessors, and use instructions stored on a computer-accessible medium (e.g., RAM, ROM, hard drive, or other storage device).

As shown in FIG. 7, for example a computer-accessible medium 715 (e.g., as described herein above, a storage device such as a hard disk, floppy disk, memory stick, CD-ROM, RAM, ROM, etc., or a collection thereof) can be provided (e.g., in communication with the processing arrangement 705). The computer-accessible medium 715 can contain executable instructions 720 thereon. In addition or alternatively, a storage arrangement 725 can be provided separately from the computer-accessible medium 715, which can provide the instructions to the processing arrangement 705 so as to configure the processing arrangement to execute certain exemplary procedures, processes, and methods, as described herein above, for example.

Further, the exemplary processing arrangement 705 can be provided with or include an input/output ports 735, which can include, for example a wired network, a wireless network, the internet, an intranet, a data collection probe, a sensor, etc. As shown in FIG. 7, the exemplary processing arrangement 705 can be in communication with an exemplary display arrangement 730, which, according to certain exemplary embodiments of the present disclosure, can be a touch-screen configured for inputting information to the processing arrangement in addition to outputting information from the processing arrangement, for example. Further, the exemplary display arrangement 730 and/or a storage arrangement 725 can be used to display and/or store data in a user-accessible format and/or user-readable format.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

1. A non-transitory computer-accessible medium having stored thereon computer-executable instructions for providing feedback on at least one section of computer code, wherein, when a computer arrangement executes the instructions, the computer arrangement is configured to perform procedures comprising:
receiving the at least one section of computer code while the at least one section is being generated by at least one user;
identifying at least one portion of the at least one section based on a label associated with the at least one portion, wherein the label is located in a comments section associated with, and separated from, the computer code;
analyzing the at least one portion of the at least one section while the at least one section is being generated by the at least one user;
generating the feedback on the analyzed portion, in real time while the at least one section is being generated by the at least one user, using a machine learning procedure, wherein the feedback includes at least one of an approval or a rejection of the at least one portion;
providing the feedback to the at least one user; and
storing the feedback in a file that includes changes made by the at least one user to the at least one portion based on the feedback.

2. The computer-accessible medium of claim 1, wherein the machine learning procedure is a recurrent neural network.

3-5. (canceled)

6. The computer-accessible medium of claim 1, wherein the at least one portion is a topic model associated with the computer code.

7. (canceled)

8. The computer-accessible medium of claim 1, wherein the computer arrangement is further configured to identify semantics of the at least one portion and provide feedback based on the semantics.

9. The computer-accessible medium of claim 1, wherein the computer arrangement is further configured to determine if the at least one portion is expected code or unexpected code using the machine learning procedure.

10. The computer-accessible medium of claim 1, wherein the receiving of the at least one section includes continuously receiving the at least one section.

11. The computer-accessible medium of claim 1, wherein the computer arrangement is configured to analyze the at least one portion by comparing the at least one portion with a previous portion of a further computer code.

12. The computer-accessible medium of claim 11, wherein the computer arrangement is further configured to determine if the at least one portion will be rejected or accepted based on the analysis of the at least one portion.

13. The computer-accessible medium of claim 1, wherein the feedback includes highlighting at least one area of the at least one portion using a particular color based on the feedback.

14. The computer-accessible medium of claim 1, wherein the feedback includes a text output including a description of any issues determined with the at least one portion.

15. The computer-accessible medium of claim 1, wherein the computer arrangement is further configured to generate the machine learning procedure.

16. The computer-accessible medium of claim 15, wherein the computer arrangement is configured to generate the machine learning procedure based on manual feedback provided for further computer code.

17. A method for providing feedback on at least one section of computer code, comprising:
receiving a plurality of further sections of further computer code;
generating at least one model for predicting the feedback based on the further sections;
receiving at least one section of computer code while the at least one section is being generated by at least one user;
identifying at least one portion of the at least one section based on a label associated with the at least one portion, wherein the label is located in a comments section associated with, and separated from, the at least one section of computer code;
providing the feedback, in real time while the at least one section is being generated by at least one user, by applying the at least one model to the at least one portion, wherein the feedback includes at least one of an approval or a rejection of the at least one portion;
storing the feedback in a file that includes changes made by the at least one user to the at least one portion based on the feedback
receiving information regarding a manual review of the feedback; and
modifying the at least one model based on the information.

18. The method of claim 17, wherein the at least one model is a recurrent neural network.

19. A system for providing feedback on at least one section of computer code, comprising:
a computer hardware arrangement configured to:
receive the at least one section of computer code from at least one user while the at least one section is being generated by the at least one user;
identifying at least one portion of the at least one section based on a label associated with the at least one portion, wherein the label is located in a comments section associated with, and separated from, the at least one section of computer code;
analyze the at least one portion, while the at least one section is being generated by the at least one user, by comparing the at least one portion with (i) a previous section of a further computer code and (ii) a standard set by an organization associated with the at least one user to determine if the at least one portion will be rejected or accepted;
determine the feedback, in real time while the at least one section is being generated by the at least one user, for the analyzed at least one portion by applying a recurrent neural network to the analyzed at least one section, wherein the feedback includes at least one of an approval or a rejection of the at least one portion; and
store the feedback in a file that includes changes made by the at least one user to the at least one portion based on the feedback.

20. (canceled)

21. The computer-accessible medium of claim 1, wherein the feedback file includes at least one bookmark to the at least one portion.

22. The method of claim 17, wherein the feedback file includes at least one bookmark to the at least one portion.

23. The method of claim 17, wherein the feedback includes highlighting at least one area of the at least one portion using a particular color based on the feedback.

24. The system of claim 19, wherein the feedback file includes at least one bookmark to the at least one portion.

25. The system of claim 19, wherein the feedback includes highlighting at least one area of the at least one portion using a particular color based on the feedback.
